(19) United States
(12) Patent Application Publication
(10) Pub. No.: US 2003/0048175 A1
(43) Pub. Date: Mar. 13, 2003

(54) Portable biometric verification and storage device

(76) Inventors: Po-Tong Wang, Taipei City (TW); Sheng-Ming Wu, Taipei City (TW)

Correspondence Address: Po-Tong WANG, PO Box 82-144, TAIPEI, TW

(21) Appl. No.: 09/947,520

(22) Filed: Sep. 7, 2001

(51) Int. Cl. H04Q 1/00; G05B 19/00

(52) U.S. Cl. 340/5.83

(57) ABSTRACT

This invention represents a portable biometric verification and storage device. The portable device performs the biometric characteristics recognition or verification for providing high security of personal identification by collating digital Biometric Identification Record (BIR) stored in the device and personal activated biometric characteristics. The Biometric Identification Record (BIR) includes a memory for storing at least one or more personal biometric characteristics database and for storing at least one or more ID of each person and personal information in a portable biometric verification and storage device.

### BACKGROUND OF THE INVENTION

Because the changes of technology are rapid, the non-transferable unique biometric characteristics which include fingerprint, voiceprint, face, iris, retina, palm print and so on have been utilized to perform individual identification. Personal ID and password also have been replaced by personal specific physical traits and unique biometric characteristics to make individual identification and prevent illegal uses when people do business transactions or e-commerce over the Net. In addition, the biometric verification can combine with electronic signature to identify a person. Each person has his her) own unique feature among all humans and biometric characteristics cannot be forged by third parties; therefore, the user can do business transactions and economic activities with high security standards.

### SUMMARY OF THE INVENTION

This invention represents a portable biometric verification and storage device. It is an object of the present invention to provide high security of individual identification and provide a portable device in which biometric characteristics can be digitized and stored. The next step is to perform the user verification by collating digitized Biometric Identification Record (BIR) and personal activated biometric characteristics. Regarding the techniques for storing Biometric Identification Record BIR and materials of the apparatus, there is no specific limit. However, the Biometric Identification Record (BIR) has to include a memory for storing at least one or more personal biometric characteristics database and for storing at least one or more ID of each person and personal information in a portable biometric verification and storage device.

### BRIEF DESCRIPTION OF THE DRAWING

FIG. 1 is a flow chart to illustrate how to perform the biometric verification.

### DETAILED DESCRIPTION OF THE PREFERRED EMBODIMENT

Illustration of the following serial numbers:

1. a hand-held portable biometric verification and storage device

2. a biometric verification system

3. a central processing unit (CPU)

4. a memory device

5. an input device

6. a biometric sensor

7. a reader

8. a storage unit

This invention represents a portable biometric verification and storage device. It is therefore an object of the present invention to provide a portable device and perform the biometric identification or verification by collating digitized Biometric Identification Record (BIR) stored in the device and personal activated biometric characteristics. Therefore, the user can do business transactions and economic activities with high security standards.

The size of the portable verification device is approximately the size of a palm and easy carried by the user in a pocket. Regarding the techniques for storing Biometric Identification Record (BIR) and materials of the apparatus, there is no specific limit. However, the Biometric Identification Record (BIR) has to include a memory for storing at least one or more personal biometric characteristics database and for storing at least one or more ID of each person and personal information in a portable biometric verification and storage device.

According to the standard of International Biometric Industry Association, the non-transferable unique biometric characteristics include fingerprint, voiceprint, face, iris, retina, palm print palm shape, signature and other individual biometric characteristics. The Biometric Identification Record comprises raw data, processed data, signed data, encrypted data and feature points which are extracted by algorithm.

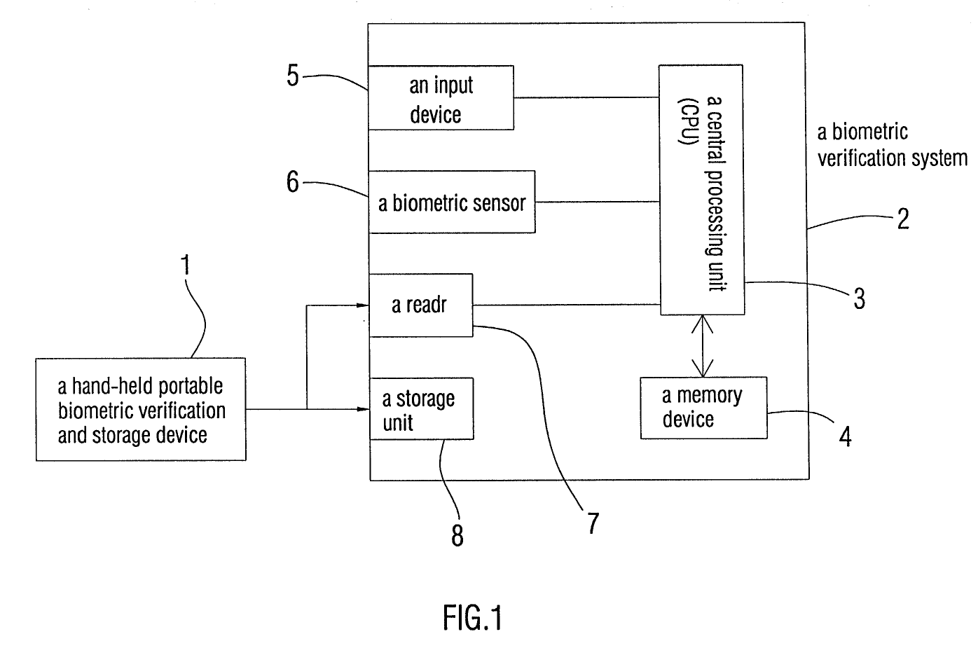

This invention represents a hand-held portable biometric verification and storage device 1 which includes Bank cards, IC cards, Credit cards, value storage cards, magnetic strip cards, smartcards, optical cards, CD, DVD, 2D Bar Code Cards, Portable magnetic storage device, portable electronic memory device and portable mobile storage device. As seen in FIG. 1, when the biometric verification system 2 plugs in the storage unit 8 to process Biometric Identification Record by calculating, collating and performing verification as a secured mechanism, it can avoid hackers or third parties to steal and forge information. Referring to the biometric verification process, the reader 7 is operated to access the biometric identification record (BIR) which includes the user's biometric data provided by the biometric sensor 6 and personal information stored in the input device 5. After receiving the Biometric Identification Record (BIR) stored in the portable biometric characteristics verification and storage device 1, the CPU 3 starts to perform verification by collating and couple to the operation of the memory device 4 for storing personal information and a temporary digital certificate. Therefore, it is as a secured mechanism to provide high security standards when the user is doing business transactions, economic activities or other transactions.

While the present invention has been described and illustrated in various preferred embodiment, it is not to be limited to the specific form or arrangement of parts herein described and shown. It will be apparent to those skilled in the art that various changes and modifications may be made without departing from the scope of the present invention and the invention is not to be considered limited to what is shown in the drawings and described in the specification.

In conclusion, the present invention has the following advantages:

1. It is a hand-held portable device carried by an individual in a pocket.

2. The portable device performs the biometric verification for providing high security of personal identification by collating digitized Biometric Identification Record (BIR) stored in the device and personal activated biometric characteristics.

3. Biometric Identification Record (BIR) has to include a memory for storing at least one or more personal biometric characteristics database and for storing at least one or more ID of each person.

4. Each person has his own unique feature among all humans; therefore, the user can do business transactions and economic activities with high security standards.

5. Biometric characteristics cannot be forged or stole by third parties.

6. The present invention can be utilized in the application of business and industry.

I claim:

1. A hand-held portable biometric verification and storage device, comprising:
the Biometric Identification Record (BIR);
a memory device for storing said Biometric Identification Record (BIR) comprising at least one or more personal biometric characteristics database, at least one or more ID of each person and personal information;
a central processing unit (CPU), operatively coupled to said memory device, for performing the biometric identification or verification to make individual identification with high security standards, and means for collating digitized said Biometric Identification Record (BIR) and personal activated biometric characteristics; and
unlimited means for having no specific limit to the techniques for storing said Biometric Identification Record BIR) and materials of said hand-held portable biometric verification and storage device.

2. The method of claim 1 wherein said hand-held portable biometric verification and storage device is easy carried by the user in a pocket and approximately the size of a palm.

3. A portable biometric verification and storage device as defined in claim 1, and further comprising the following: Bank cards, IC cards, Credit cards, value storage cards, magnetic strip cards, smartcards, optical cards, CD, DVD, 2D Bar Code Cards, Portable magnetic storage device, portable electronic memory device and portable mobile storage device.

4. The method of claim 1 wherein said biometric characteristics means for comprising fingerprint, voiceprint, face, iris, retina, palm print, palm shape, signature and other individual biometric characteristics.

5. The method of claim 1 wherein said Biometric Identification Record (BIR) means for comprising raw data, processed data, signed data, encrypted data and feature points which are extracted by algorithm
